(19) United States
(12) Patent Application Publication
(10) Pub. No.: US 2016/0226077 A1
(43) Pub. Date: Aug. 4, 2016

(54) NON-CARBON CATALYST SUPPORT PARTICLES FOR USE IN FUEL CELL ELECTRODES

(71) Applicant: Nissan North America, Inc., Franklin, TN (US)

(72) Inventors: DIANNE ATIENZA, Farmington Hills, MI (US); GREGORY DILEO, Ann Arbor, MI (US); ELLAZAR NIANGAR, Redford, MI (US); RAMESHWAR YADAV, Farmington, MI (US); AMOD KUMAR, Farmington Hills, MI (US)

(21) Appl. No.: 14/613,485

(22) Filed: Feb. 4, 2015

(51) Int. Cl. H01M 4/90

(52) U.S. Cl. CPC H01M 4/9075

(57) ABSTRACT

Non-carbon support particles for use in electrocatalyst include a first metal oxide having a high surface area doped with an electrically conductive transition metal. An example of non-carbon support particle for use in electrocatalyst comprises titanium oxide particles doped with ruthenium.

### TECHNICAL FIELD

This disclosure relates to non-carbon mixed material electrocatalyst support structures, and in particular, to a high surface area metal oxide support doped with a conductive metal used to produce electrocatalysts for hydrogen fuel cell vehicles having active catalyst particles deposited thereon.

### BACKGROUND

Carbon has traditionally been the most common material of choice for polymer electrolyte fuel cell (PEFC) electrocatalyst supports due to its low cost, high abundance, high electronic conductivity, and high Brunauer, Emmett, and Teller (BET) surface area, which permits good dispersion of platinum (Pt) active catalyst particles. However, the instability of the carbon-supported platinum electrocatalyst due at least in part to carbon corrosion is a key issue that currently precludes widespread commercialization of PEFCs for automotive applications.

The adverse consequences of carbon corrosion include (i) platinum nanoparticle agglomeration/detachment; (ii) macroscopic electrode thinning/loss of porosity in the electrode; and (iii) enhanced hydrophilicity of the remaining support surface. The first results in loss of catalyst active surface area and lower mass activity resulting from reduced platinum utilization, whereas the second and third result in a lower capacity to hold water and enhanced flooding, leading to severe condensed-phase mass transport limitations. Clearly, both consequences directly impact PEFC cost and performance, especially in the context of automotive stacks.

To address the issues with carbon-based catalyst, non-carbon alternatives are being investigated, such as metal oxides. However, some metal oxides alternatives are cost-prohibitive, and dissolution, agglomeration and corrosion of the metal oxide alternatives can still occur.

### SUMMARY

Non-carbon support particles are disclosed for use in electrocatalyst comprising a first metal oxide having a high surface area doped with an electrically conductive transition metal. An example of non-carbon support particle for use in electrocatalyst as disclosed herein comprises titanium oxide particles doped with ruthenium.

These and other aspects of the present disclosure are disclosed in the following detailed description of the embodiments, the appended claims and the accompanying figures.

### BRIEF DESCRIPTION OF THE DRAWINGS

The various features, advantages and other uses of the present apparatus will become more apparent by referring to the following detailed description and drawing in which:

FIG. 1 is a schematic of an electrode using an embodiment of the improved non-carbon catalyst support particles as disclosed herein;

FIG. 2 is a schematic of an electrode using another embodiment of the improved non-carbon catalyst support particles as disclosed herein; and

FIG. 3 is a schematic of a fuel cell using the electrode of FIG. 1 or FIG. 2 as disclosed herein.

### DETAILED DESCRIPTION

One example of a non-carbon metal oxide catalyst support consists essentially of a non-conductive metal oxide having a high surface area. A non-limiting example of such a metal oxide is titanium dioxide. Titanium dioxide (TiO₂) has very good chemical stability in acidic and oxidative environments. However, titanium dioxide is a semiconductor and its electron conductivity is very low.

To overcome the deficiencies of the non-conductive metal oxide alone, a non-carbon metal oxide support having both a non-conductive oxide and a conductive metal have been developed. Disclosed herein are non-carbon support particles for use in electrocatalyst comprising a metal oxide having a high surface area doped with an electrically conductive transition metal. Doping the high surface area metal oxide with a conductive transition metal provides the requisite electron conductivity. Doping the conductive transition metal can also reduce or eliminate dissolution and agglomeration of the metal that can arise when one particle is deposited on another particle, as doping chemically bonds the conductive metal to the metal oxide support. The doped support particle provides greater stability than support particles comprised of a conductive metal deposited on a non-conductive, high surface area metal oxide. Doping the metal oxide with the conductive metal also maintains the high surface area of the metal oxide support on which the active catalyst particles are deposited.

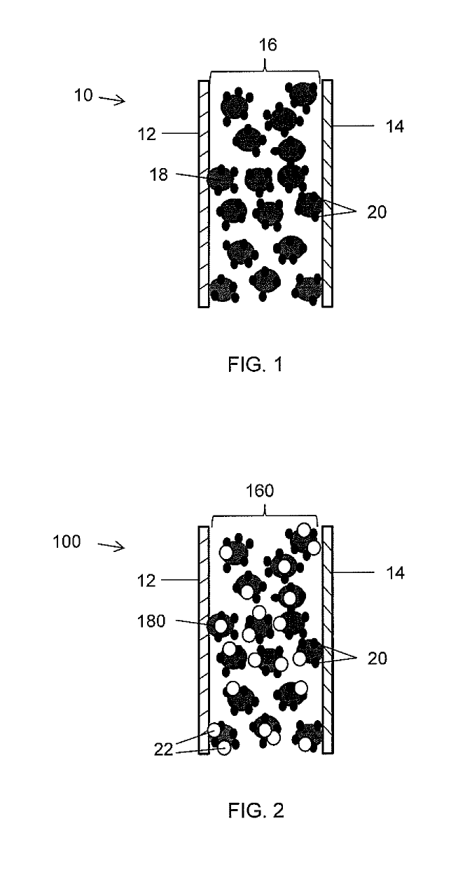

FIG. 1 illustrates an electrode 10 for a fuel cell using one embodiment of a non-carbon support particle for use in electrocatalyst as disclosed herein. A catalyst layer 16 is positioned between a membrane 12 and a gas diffusion layer 14. The catalyst layer 16 comprises catalyst support particles 18 consisting essentially of a high surface area metal oxide doped with a conductive metal. Active catalyst particles 20 are supported on the catalyst support particles 18. The catalyst layer 16 can further include an ionomer and a binder.

The metal oxide in the catalyst support particles 18 is a high surface area metal oxide with low electron conductivity. As used herein, “low electron conductivity” refers to those metal oxides having insufficient electron conductivity to be used solely as the electron conductor in fuel cell catalyst and include metal oxides that do not conduct electrons. The metal oxide can be one or more metal oxides prepared with varying ratios of metal oxides and various particle sizes depending on the metal oxides used. As non-limiting examples, the metal oxide in the catalyst support particles 18 can be titanium dioxide.

The metal oxide of the catalyst support particles 18 is doped with a conductive metal, preferably a conductive transition metal. As a non-limiting example, the transition metal can be ruthenium. The metal oxide will have a larger particle size than the conductive transition metal and be doped with the conductive transition metal, making the catalyst support particle 18 electron conductive while maintaining the high surface area.

Active catalyst particles 20 are deposited onto the catalyst support particles 18. The active catalyst particles 20 can include one or a combination of precious metals such as platinum, gold, rhodium, ruthenium, palladium and iridium, and/or transition metals such as cobalt and nickel. The precious metal can be in various forms, such as alloys, nanowires, nanoparticles and coreshells, which are bimetallic catalysts that possess a base metal core surrounded by a precious metal shell.

FIG. 2 illustrates an electrode 100 for a fuel cell using another embodiment of a non-carbon support particle for use in electrocatalyst as disclosed herein. A catalyst layer 160 is positioned between a membrane 12 and a gas diffusion layer 14. The catalyst layer 160 comprises catalyst support particles 180 consisting essentially of a high surface area metal oxide doped with a conductive metal, such as a conductive transition metal. In this embodiment, the catalyst support particles 180 further include a conductive metal oxide 22 deposited onto the doped high surface area metal oxide. The addition of the conductive metal oxide 22 to the catalyst support particles 180 improves oxygen evolution reaction (OER) activity. Active catalyst particles 20 are supported on the catalyst support particles 180. The catalyst layer 160 can further include an ionomer and a binder.

The conductive metal oxide can be an oxide of the conductive transition metal with which the high surface area metal oxide is doped. For example, the conductive transition metal can be ruthenium and the conductive metal oxide can be ruthenium dioxide. Alternatively, the conductive metal oxide can be an oxide of a different metal than the conductive transition metal. For example, the conductive transition metal can be ruthenium and the conductive metal oxide can be iridium oxide. The high surface area metal oxide can have a particle size greater than the particle size of the conductive metal oxide.

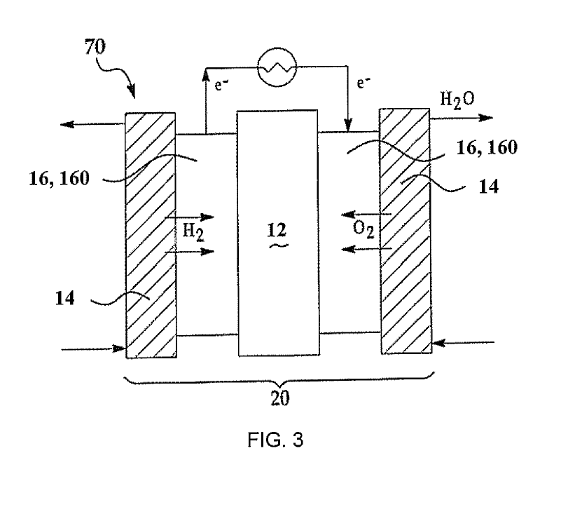

FIG. 3 illustrates the use of catalyst support particles, 18, 180 disclosed herein. FIG. 3 is a schematic of a fuel cell 70, a plurality of which makes a fuel cell stack. The fuel cell 70 is comprised of a single membrane electrode assembly 20. The membrane electrode assembly 20 has a membrane 12 coated with the catalyst layer 16, 160 with a gas diffusion layer 14 on opposing sides of the membrane 12. The membrane 12 has catalyst layers 16, 160 formed on opposing surfaces of the membrane 12, such that when assembled, the catalyst layers 16, 160 are each between the membrane 12 and a gas diffusion layer 14. Alternatively, a gas diffusion electrode is made by forming a catalyst layer 16, 160 on a surface of a gas diffusion layer 14 and layering the membrane 12 on the catalyst layer 16, 160. In FIG. 3, the membrane 12 is sandwiched between two gas diffusion layers 14 such that the catalyst layers 16, 160 contact the membrane 12. When fuel, such as hydrogen gas (shown as H₂), is introduced into the fuel cell 70, the catalyst layer 16, 160 splits hydrogen gas molecules into protons and electrons. The protons pass through the membrane 12 to react with the oxidant (shown as O₂), such as oxygen or air, forming water (H₂O). The electrons (e⁻), which cannot pass through the membrane 12, must travel around it, thus creating the source of electrical energy.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A non-carbon support particle for use in electrocatalyst comprising a first metal oxide doped with an electrically conductive elemental transition metal.

2. The non-carbon support particle of claim 1, wherein the first metal oxide is titanium dioxide.

3. The non-carbon support particle of claim 1, wherein the transition metal is ruthenium.

4. The non-carbon support particle of claim 1, further comprising a second metal oxide deposited on the doped first metal oxide, wherein the second metal oxide is electronically conductive and the first metal oxide has low electron conductivity compared to the second metal oxide.

5. The non-carbon support particle of claim 4, wherein the transition metal is ruthenium and the second metal oxide is ruthenium dioxide.

6. The non-carbon support particle of claim 4, wherein the first metal oxide has a first particle size and the second metal oxide has a second particle size, wherein the first particle size is greater than the second particle size.

7. The non-carbon support particle of claim 1, wherein the first metal oxide has a first particle size and the transition metal has a second particle size, wherein the first particle size is greater than the second particle size.

8. An electrocatalyst comprising the non-carbon support particles of claim 1 and further comprising non-carbon active catalyst particles deposited onto the non-carbon support particles.

9. An electrode assembly for a fuel cell comprising the electrocatalyst of claim 8.

10. A non-carbon support particle for use in electrocatalyst comprising titanium oxide particles doped with elemental ruthenium.

11. The non-carbon support particle of claim 10, further comprising ruthenium dioxide particles deposited on the titanium oxide particles.

12. The non-carbon support particle of claim 11, wherein the titanium oxide particles have a first particle size and the ruthenium dioxide particles have a second particle size, wherein the first particle size is greater than the second particle size.

13. An electrocatalyst comprising the non-carbon support particles of claim 10 and further comprising non-carbon active catalyst particles deposited onto the non-carbon support particles.

14. An electrode assembly for a fuel cell comprising the electrocatalyst of claim 13.
